(19) United States
(12) Patent Application Publication
(10) Pub. No.: US 2008/0022378 A1
(43) Pub. Date: Jan. 24, 2008

(54) Restricting malicious libraries

(76) Inventors: Rolf Repasi, Sunrise Beach (AU); Simon Clausen, New South Wales (AU)

Correspondence Address: BRINKS HOFER GILSON & LIONE, P.O. BOX 10395, CHICAGO, IL, 60610, US

(21) Appl. No.: 11/820,763

(22) Filed: Jun. 20, 2007

Related U.S. Application Data
(60) Provisional application No. 60/815,319, filed on Jun. 21, 2006.

(51) Int. Cl. H04L 9/32

(52) U.S. Cl. 726/5

(57) ABSTRACT

A method, system and/or a computer program product for of restricting a request to load or register a malicious library in a processing system. The method comprises steps of: intercepting, in an API call of the processing system, wherein the API call is a request to load or register a library; determining if the library is malicious; and in response to determining that the library is malicious, restricting the request to load or register the malicious library.

This application claims the benefit of priority from Provisional Application Ser. No. 60/815,319, filed on Jun. 21, 2006, which is hereby incorporated by reference in its entirety.

### TECHNICAL FIELD

The present invention generally relates to a method, system, computer readable medium of instructions and/or computer program product for restricting a request to load and/or and register a malicious library in a processing system.

### BACKGROUND ART

As used herein a “threat” comprises malicious software, also known as “malware” or “pestware”, which comprises software that is included or inserted in a part of a processing system or processing systems for a harmful purpose. The term threat should be read to comprise possible, potential and actual threats. Types of malware can comprise, but are not limited to, malicious libraries, viruses, worms, Trojans, adware, malicious active content and denial of service attacks. In the case of invasion of privacy for the purposes of fraud or theft of identity, malicious software that passively observes the use of a computer is known as “spyware”.

A hook (also known as a hook procedure or hook function), as used herein, generally refers to a callback function provided by a software application that receives certain data before the normal or intended recipient of the data. A hook function can thus examine or modify certain data before passing on the data. Therefore, a hook function allows a software application to examine data before the data is passed to the intended recipient.

An API (“Application Programming Interface”) hook (also known as an API interception), as used herein as a type of hook, refers to a callback function provided by an application that replaces functionality provided by an operating system's API. An API generally refers to an interface that is defined in terms of a set of functions and procedures, and enables a program to gain access to facilities within an application. An API hook can be inserted between an API call and an API procedure to examine or modify function parameters before passing parameters on to an actual or intended function. An API hook may also choose not to pass on certain types of requests to an actual or intended function.

A process, as used herein, is at least one of a running software program or other computing operation, or a part of a running software program or other computing operation, that performs a task.

A hook chain as used herein, is a list of pointers to special, application-defined callback functions called hook procedures. When a message occurs that is associated with a particular type of hook, the operating system passes the message to each hook procedure referenced in the hook chain, one after the other. The action of a hook procedure can depend on the type of hook involved. For example, the hook procedures for some types of hooks can only monitor messages, others can modify messages or stop their progress through the chain, restricting them from reaching the next hook procedure or a destination window.

A kernel, as used herein, refers to the core part of an operating system, responsible for resource allocation, low-level hardware interfaces, security, etc.

An interrupt, as used herein, is at least one of a signal to a processing system that stops the execution of a running program so that another action can be performed, or a circuit that conveys a signal stopping the execution of a running program.

A library is a file containing executable code and data which can be loaded by a process at load time or run time, rather than during linking. There are several forms of a library comprising, but not limited to, Dynamic Linked Libraries (DLL), Layered Service Provider (LSP), drivers, Active X technologies, and other related services.

In a networked information or data communications system, a user has access to one or more terminals which are capable of requesting and/or receiving information or data from local or remote information sources. In such a communications system, a terminal may be a type of processing system, computer or computerised device, personal computer (PC), mobile, cellular or satellite telephone, mobile data terminal, portable computer, Personal Digital Assistant (PDA), pager, thin client, or any other similar type of digital electronic device. The capability of such a terminal to request and/or receive information or data can be provided by software, hardware and/or firmware. A terminal may comprise or be associated with other devices, for example a local data storage device such as a hard disk drive or solid state drive.

An information source can comprise a server, or any type of terminal, that may be associated with one or more storage devices that are able to store information or data, for example in one or more databases residing on a storage device. The exchange of information (ie. the request and/or receipt of information or data) between a terminal and an information source, or other terminal(s), is facilitated by a communication means. The communication means can be realised by physical cables, for example a metallic cable such as a telephone line, semi-conducting cables, electromagnetic signals, for example radio-frequency signals or infra-red signals, optical fibre cables, satellite links or any other such medium or combination thereof connected to a network infrastructure.

A system registry is a database used by all modern operating systems, for example Windows™ platforms. The system registry comprises information needed to configure the operating system. The operating system refers to the registry for information ranging from user profiles, to which applications are installed on the machine, to what hardware is installed and which ports are registered.

Currently software is able to load and register malicious libraries on a user's processing system. Such malicious libraries may interfere with normal operation of the processing system, such as:
Conceal certain objects within an operating system of the processing system;
Modify memory of running processes;
Terminate or restrict processes from starting;
Create system instability;
Perform spyware-like or virus-like actions; and/or
Modify the behaviour of particular or all running applications.

Current methods of restricting such malicious libraries comprise scanning software products or real time software monitoring products.

Scanning products scan process memory for known malicious system libraries. Scanning products may additionally scan the system registry for references to known malicious system libraries. However, disadvantages to such scanning products comprise:
A scan needs to be invoked by the user or the user must schedule the scan to be performed. Until a scan is performed, malicious activities can be performed by the malicious libraries.
If a scan detects a malicious library loaded by one or more processes, then either:
   Those processes need to be terminated, which can be inconvenient to the user;
   An attempt can be made to unload the malicious system library or libraries, however, this can often leave the process in an unstable state, causing unpredictable results or crashes;
   If any of the processes are critical system processes, then the system needs to be rebooted for successful deactivation of the malicious system library or libraries which can be inconvenient.

Real time software monitoring products can monitor or protect areas of the system registry which store a list of installed system libraries. This can be achieved by either API hooking or polling for modifications to the list at regular intervals. However, the disadvantages to such real time software monitoring products comprise:
If a modification is detected to sections of the system registry which store the list of installed system libraries using API hooking, then either:
   The process which attempted to make the modification has to be paused until the modified section of the registry has been fully scanned, which can reduce the performance of the processing system;
   All required information to perform a scan may not be available as the process attempting to perform further changes to the registry has been paused or suspended;
If a modification is detected using the polling technique then:
   A snapshot of installed system libraries has to be maintained which may cause unwanted bursts of CPU activity during polling; and
   There is difficulty in determining which process performed the modification to the registry.

Real time software monitoring product cannot restrict or prevent malicious system libraries being activated by one or more processes performed in the processing system.

There exists a need for a method, system, computer readable medium of instructions, and/or a computer program product to at least restrict or prevent loading of malicious libraries in a processing system which address or at least ameliorate one or more problems inherent in the prior art.

There also exists a need for a method, system, computer readable medium of instructions, and/or a computer program product to at least restrict or prevent registration of malicious libraries in a processing system which address or at least ameliorate one or more problems inherent in the prior art.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

### DISCLOSURE OF INVENTION

In a first broad form there is provided a method of restricting a request to load or register a malicious library in a processing system, the method comprising:

intercepting, in the processing system, a request to load or register a library;

determining if the library is malicious; and

in response to determining that the library is malicious, restricting the request to load or register the malicious library.

In one form, intercepting the request comprises intercepting, using an API hook function, an API call to request the library to load or register the library.

In another form, in the event that the library is determined to be malicious, the method comprises restricting the API call propagating through an API hook chain associated with the API call.

In one embodiment, the method comprises:

determining identification data identifying the requested library; and

using a detection module and the identification data to determine if the library is malicious.

In another embodiment, the method comprises analyzing, using the detection module, at least one of the intercepted request and a data storage element of the processing system to determine whether the library is malicious.

In an optional form, the detection module comprises a one or more submodules comprising at least one of a cryptographic hash module, a checksum module, a disassembly module, a black-list/white-list module, a relationship analysis module, and a pattern matching module, wherein the method comprises analysing, using the one or more submodules, at least one of the intercepted request and the data storage element of the processing system to determine whether the library is malicious.

In another optional form, the method comprises:

generating, using the cryptographic hash module, a cryptographic hash value of an entity associated with the request, wherein the entity is stored on or associated with the data storage element of the processing system; and

comparing the cryptographic hash value to a database to determine whether the library is malicious, wherein the database comprises a plurality of cryptographic hash values identifying malicious entities.

In an optional embodiment, the method comprises:

generating, using the checksum module, a checksum value of an entity associated with the request, wherein the entity is stored on or associated with the data storage element of the processing system; and

comparing, using the black-list/white-list module, the checksum value to a list to determine whether the library is malicious, wherein the list comprises records indicative of malicious entities and non-malicious entities.

In another optional embodiment, the method comprises:

disassembling, using the disassembly module, an entity associated with the request, wherein the entity is stored on or associated with the data storage element of the processing system; and

performing a comparison, using the pattern matching module, between the disassembled entity and a list of patterns associated with malicious activity.

In one aspect, in the event that the library is determined to be malicious, the method comprises:
(a) setting the malicious library as a base entity;
(b) determining an entity property of the base entity;
(c) determining, using the relationship analysis module, one or more related entities to the base entity which are related by the entity property; and
(d) performing, using the detection module, an analysis of the related entities to determine if one or more of the related entities are malicious.

In another aspect, the method comprises:

setting the one or more related entities as the base entity; and

repeating steps (b) and (c), followed by step (d) until an end condition is satisfied.

In one form, the end condition is at least one of:

when no related entities are determined in a particular repetition;

when no new related entities are determined in a particular repetition;

when no related entities are determined in a period of time;

when the base entity has an entity property which is indicative of the end condition; and

when a selected number of repetitions have been performed.

In another form, the method comprises:

in response to determining that the library is malicious:
scanning a system registry of the processing system for references to the malicious library; and
in the event of detecting a record in the system registry comprising a reference to the malicious library, removing the reference from the record.

In a second broad form there is provided a system to restrict a request to load or register a malicious library in a processing system, the system being configured to:

intercept, in the processing system, a request to load or register a library;

determine if the library is malicious; and

in response to determining that the library is malicious, restrict the request to load or register the malicious library.

In particular forms, the processing system is configured to perform any one of the above described methods.

In a third broad form there is provided a computer program product for a processing system, the computer program product comprising a computer readable medium having a computer program recorded therein or thereon, the computer program product being configured to enable restriction of a request to load or register a malicious library in the processing system, wherein the computer program product configures the processing system to:

intercept, in the processing system, a request to load or register a library;

determine if the library is malicious; and

in response to determining that the library is malicious, restrict the request to load or register the malicious library.

In particular forms, the computer program product is configured to enable any one of the above-described methods to be performed by the processing system.

According to another broad form, the present invention provides a computer readable medium of instructions for giving effect to any of the aforementioned methods or systems. In one particular, but non-limiting, form, the computer readable medium of instructions are embodied as a software program.

### BRIEF DESCRIPTION OF FIGURES

An example embodiment of the present invention should become apparent from the following description, which is given by way of example only, of a preferred but non-limiting embodiment, described in connection with the accompanying figures.

FIG. 1 illustrates a functional block diagram of an example of a processing system that can be utilised to embody or give effect to a particular embodiment;

FIG. 2A illustrates a known method of loading a library in a processing system;

FIG. 2B illustrates a known method of registering a library in a processing system;

FIG. 3 illustrates flow diagram of an example method of intercepting an API call to an API procedure.

FIG. 4 illustrates a flow diagram of an example method to restrict a request to load a malicious library in a processing system;

FIGS. 5A and 5B illustrate a flow diagram of a more detailed example of the method illustrated in FIG. 4;

FIG. 6 illustrates a flow diagram of an example method to restrict a request to register a malicious library in a processing system;

FIGS. 7A and 7B illustrate a flow diagram of more detailed example of the method illustrated in FIG. 6;

FIG. 8A illustrates a functional block diagram representing an example system to restrict a request to load a malicious library in a processing system;

FIG. 8B illustrates a functional block diagram representing an example system to restrict a request to register a malicious library in a processing system.

FIG. 9 illustrates a block diagram representing an example of a detection module and sub-modules; and

FIG. 10 illustrates a functional block diagram representing an example of the operation of a relationship analysis module.

### MODES FOR CARRYING OUT THE INVENTION

The following modes, given by way of example only, are described in order to provide a more precise understanding of the subject matter of a preferred embodiment or embodiments.

In the figures, incorporated to illustrate features of an example embodiment, like reference numerals are used to identify like parts throughout the figures.

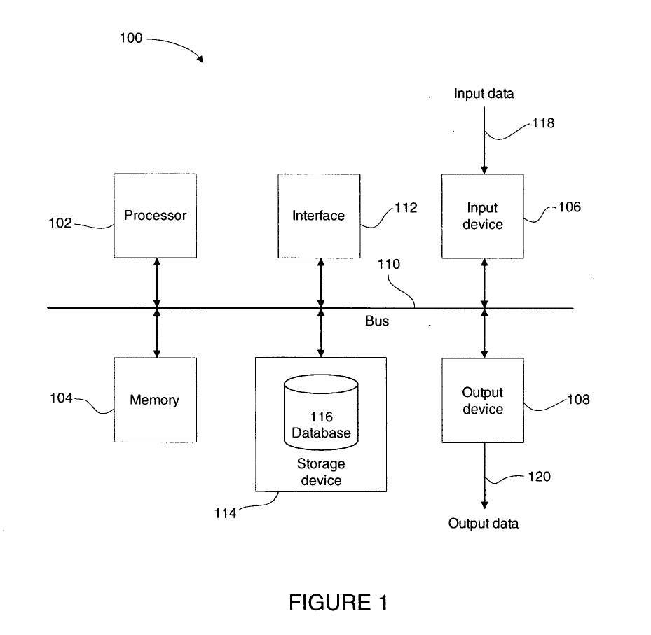

A particular embodiment of the present invention can be realised using a processing system, an example of which is shown in FIG. 1. In particular, the processing system 100 generally comprises at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could comprise more than one distinct processing device, for example to handle different functions within the processing system 100. Input device 106 receives input data 118 and can comprise, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can comprise, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116. The interface 112 may allow wired and/or wireless communication between the processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the processing system 100 may be any form of terminal, server, specialised hardware, or the like.

The processing system 100 may be a part of a networked communications system. Processing system 100 could connect to network, for example the Internet or a WAN. Input data 118 and output data 120 could be communicated to other devices via the network. The transfer of information and/or data over the network can be achieved using wired communications means or wireless communications means. A server can facilitate the transfer of data between the network and one or more databases. A server and one or more databases provide an example of an information source.

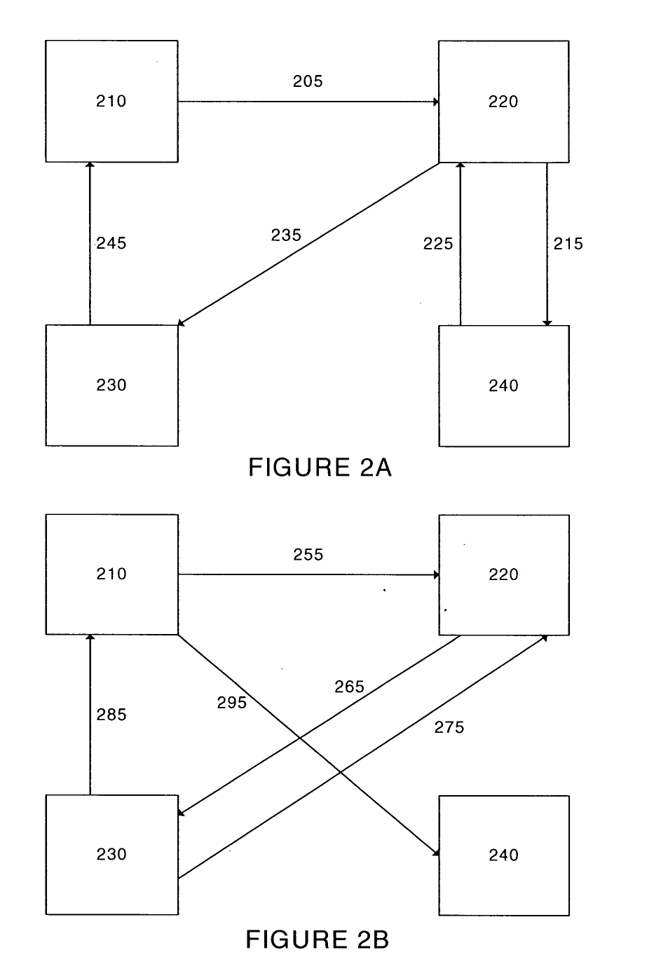

Referring now to FIG. 2A, there is shown a block diagram illustrating an example of a known process of loading a library in a processing system.

In particular, a process 210 transfers, as indicated by arrow 205, an API call to an operating system 220 of the processing system 100, where the API call is indicative of a request to load of a library. The request generally comprises an identity associated with the library to be loaded. The operating system queries, as indicated by arrow 215, a system library registry 240, to determine the filename which corresponds to the identity, and the system library registry 240 transfers, as indicated by arrow 225, the filename back to the operating system 220. The operating system 220 then loads an instance of the library from the system library store 230 to the process' address space, as indicated by arrow 235, and the system library store 230 returns an identifier, cookie or handle for the loaded instance of the library to the process 210.

Referring now to FIG. 2B, there is shown a block diagram illustrating an example of a known process of registering a library in a processing system.

In particular, the process 210 transfers, as indicated by arrow 255, an API call to the operating system 220 of the processing system 100, where the API call is indicative of a request to register a library. The request generally comprises a request to obtain an address for a registration function of the library. The operating system 220 queries, as indicated by arrow 265, the system library store 230 for the address of the registration function for the library. The system library store 230 transfers, as indicated by arrow 275, the address of the library to operating system 220, such that the operating system loads the library into the address space of the process 210. The system library store 230 also transfers, as indicated by arrow 285, the address of the registration function to the process 210. The process 210 then invokes the registration function of the library such as to register the library in the system registry 240, as indicated by arrow 295.

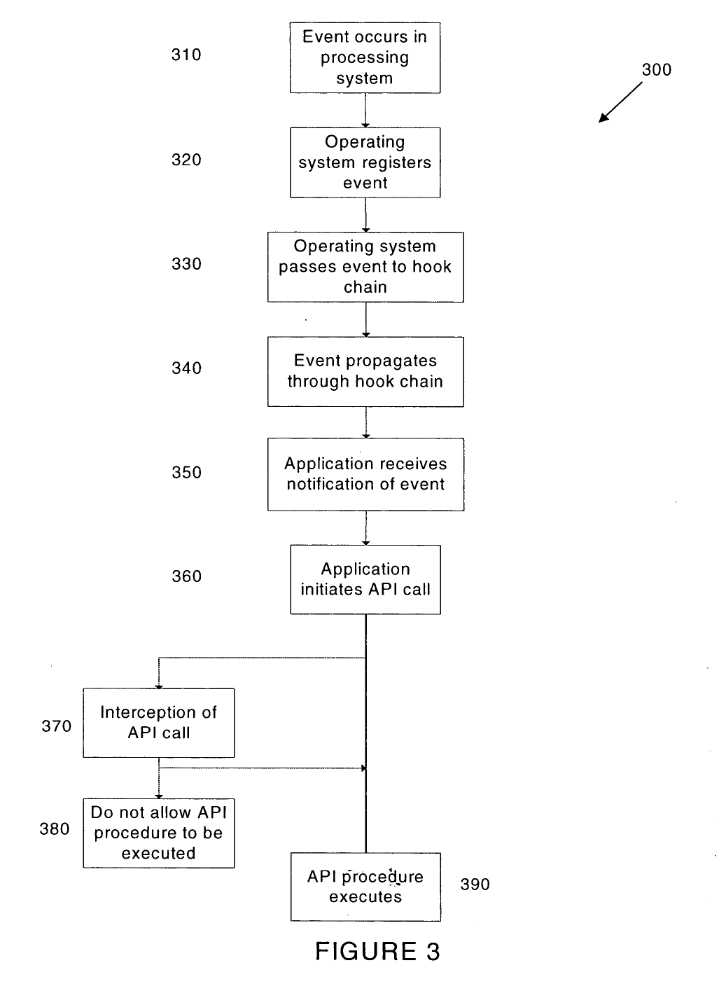

Referring now to FIG. 3, there is illustrated an example flow chart showing the process 300 of intercepting an API call.

In particular, at step 310, an event occurs in the processing system. At step 320, the operating system running in the processing system 100 registers the occurrence of the event. At step 330, the operating system passes the registered event to the API hook chain. At step 340, the event is passed to each API hook in the API hook chain such that different applications, processes, and devices may be notified of the registered event. Once the event has propagated throughout the API hook chain, the method comprises at step 350 an application receiving notification of the event being registered by the processing system. At step 360, the application initiates an API call to an API procedure so as to carry out a response to the registered event. If an API hook has been established between the API call and the API procedure, the API call is intercepted at step 370 before it reaches the API procedure. The API call may be allowed to continue calling the API procedure at step 390 or the API call may not be passed on to the API procedure, as shown at step 380.

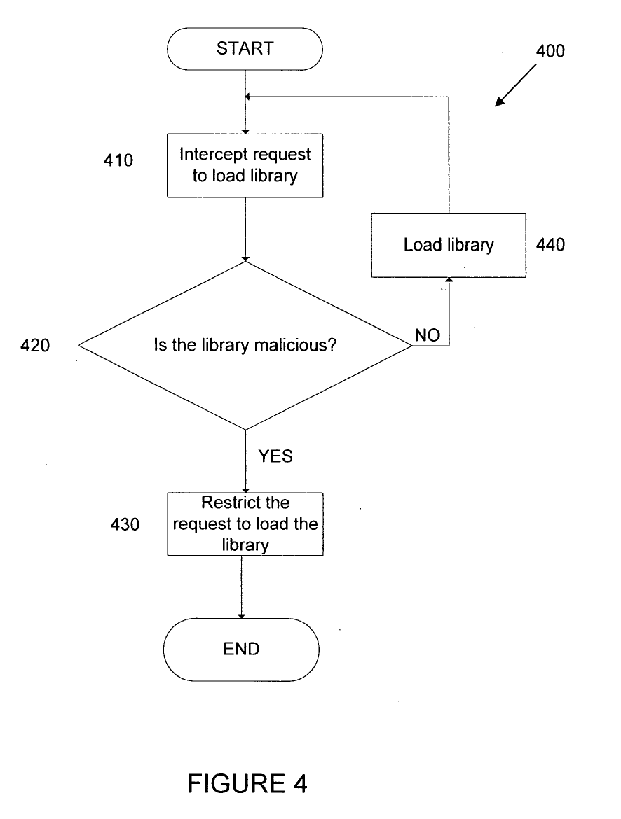

Referring now to FIG. 4, there is shown a flow diagram illustrating an example method to restrict a request to load a malicious library in a processing system 100.

In particular, the method 400 comprises at step 410 intercepting an API call to load a library. The process of intercepting an API call has previously been discussed in relation to FIG. 3. At step 420, the method comprises determining whether the library is malicious. This can be performed using a detection module 820, as will be described in more detail below.

If the library is determined to be non-malicious, the library is loaded at step 420 in the normal manner indicated in FIG. 2A. The method 400 continues to monitor any further API calls to load other libraries in the processing system. In the event that the library is determined to be malicious, the method continues to step 430 where the method comprises restricting the request to load the malicious library.

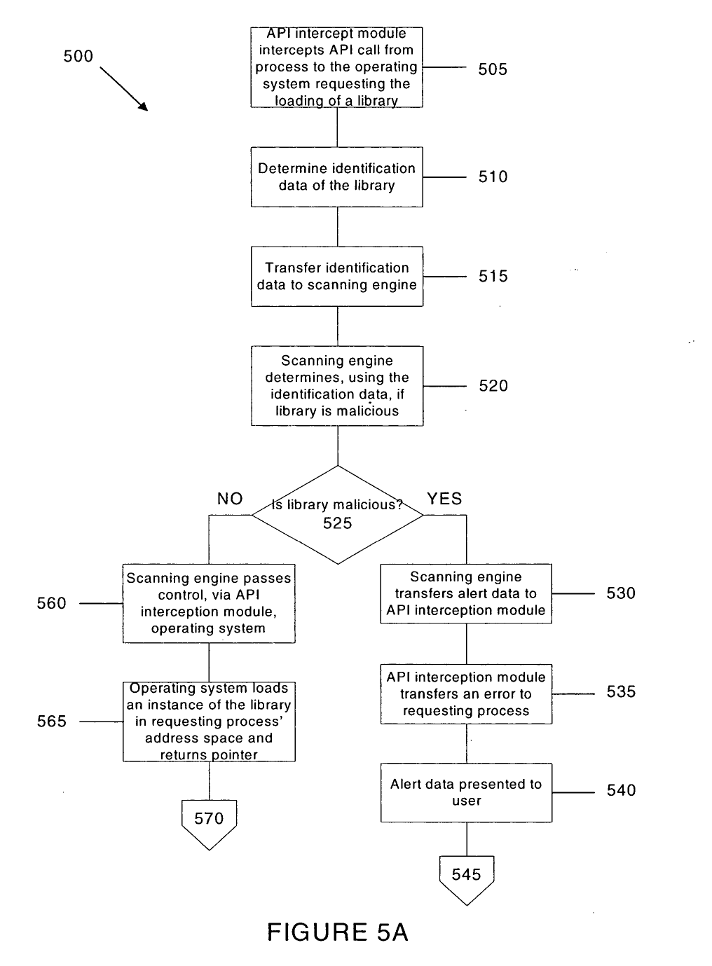

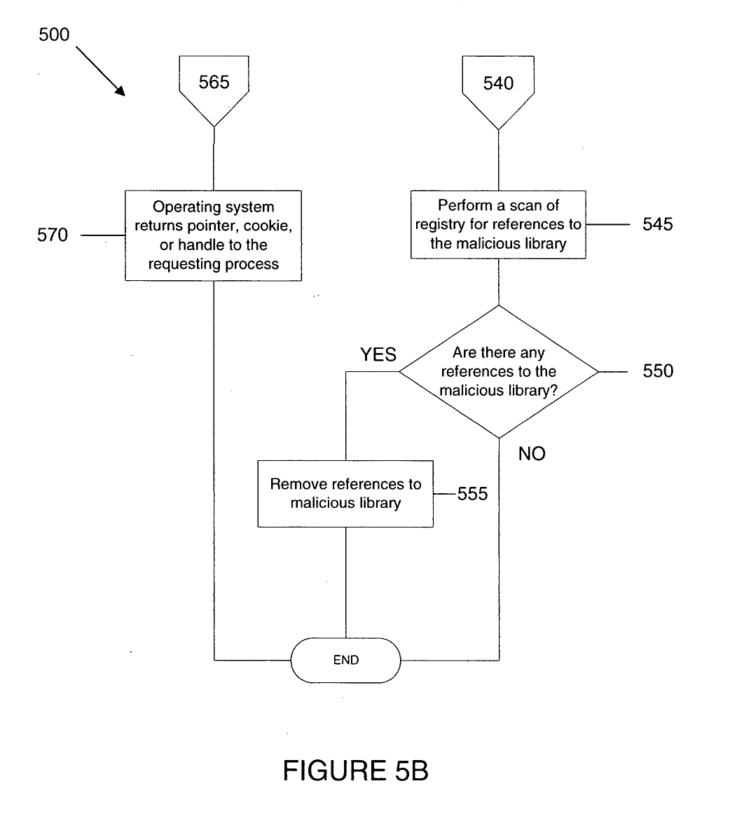

Referring now to FIGS. 5A and 5B, there is shown a flow diagram illustrating a more detailed example of the method illustrated in FIG. 4.

In particular at step 505, the method 500 comprises an API interception module 810 intercepting an API call from a process requesting to load a library. At step 510 the method 500 comprises determining identification data of the requested library. At step 515, the method 500 comprises transferring the identification data to the detection module 820. At step 520, the method 500 comprises the detection module 820 determining, using the identification data, if the library is malicious. A number of sub-modules, such as a cryptographic hash module 910, a checksum module 920, a disassembly module 930, a blacklist/whitelist module 940, a relationship analysis module 950, and/or a pattern matching module 960 can be used by the detection module 820 to determine whether the library is malicious. Each of these sub-modules will be discussed in more detail below.

If the detection module 820 determines at step 525 that the library is malicious, the method proceeds to step 530. In particular, at step 530 the method 500 comprises the detection module 820 transferring alert data to the API interception module 810. The alert data is indicative of the identification of the library considered malicious. At step 535 the method 500 comprises the API interception module 810 transferring an error to the requesting process, thus restricting the library to load. The error transferred to the requesting process is indicative of the library failing to load. At step 540, the method 500 optionally comprises presenting the alert data to the user of the processing system 100. In one form, the alert data may be a pop-up window alerting the user of the identification of the request to load the malicious library.

At step 545, the method 500 optionally comprises the processing system 100 performing a scan of the system registry 240 for references to the malicious library. In particular, the detection module 820 may be invoked by the processing system 100 such as to determine whether there are any references to the malicious library in the system registry 240, as indicated at step 550. In the event that there are references to the malicious library in the system registry 240, the method 500 comprises removing the references to the malicious library from the system registry 240 at step 555.

Returning to step 525 of method 500, in the event that the library is not considered malicious, the scanning engine 820 passes control, via the API interception module 810 to the operating system 220 at step 560. At step 565, the method 500 comprises the operating system 220 loading an instance of the library in the requesting process' address space. At step 570, the method 500 comprises the operating system 220 returning a pointer, cookie, or handle to the requesting process.

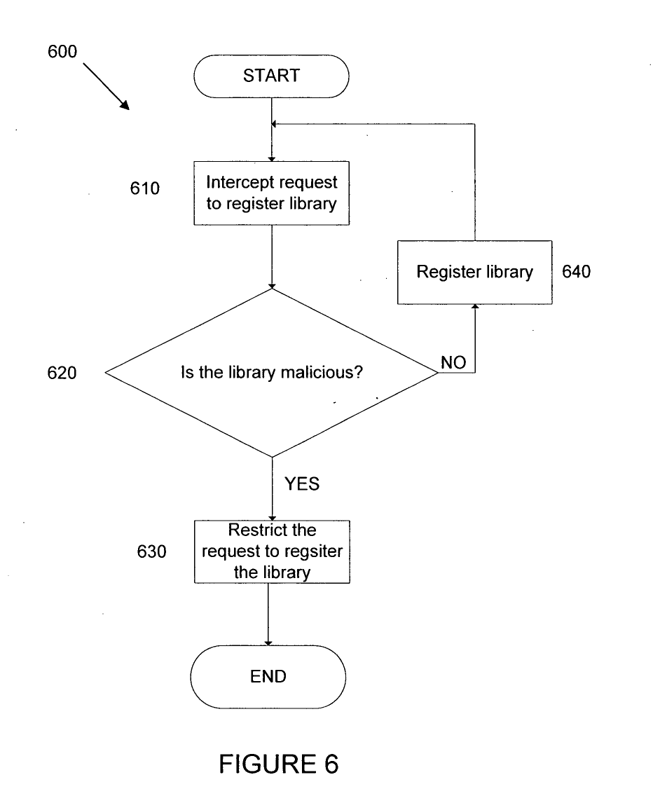

Referring now to FIG. 6, there is shown a flow diagram illustrating an example of a method to restrict a request to register a malicious library in a processing system.

In particular, at step 610, the method 600 comprises intercepting an API call to register a library. The process of intercepting an API call has previously been discussed in relation to FIG. 3. At step 620, the method 600 comprises determining whether the library is malicious. In the event that the library is determined to be non-malicious, the method 600 proceeds to step 640 where the library is registered. The method 600 continues to monitor API calls to register other libraries. In the event that the library is determined to be malicious, the method 600 continues to step 630 where the library is restricted from loading.

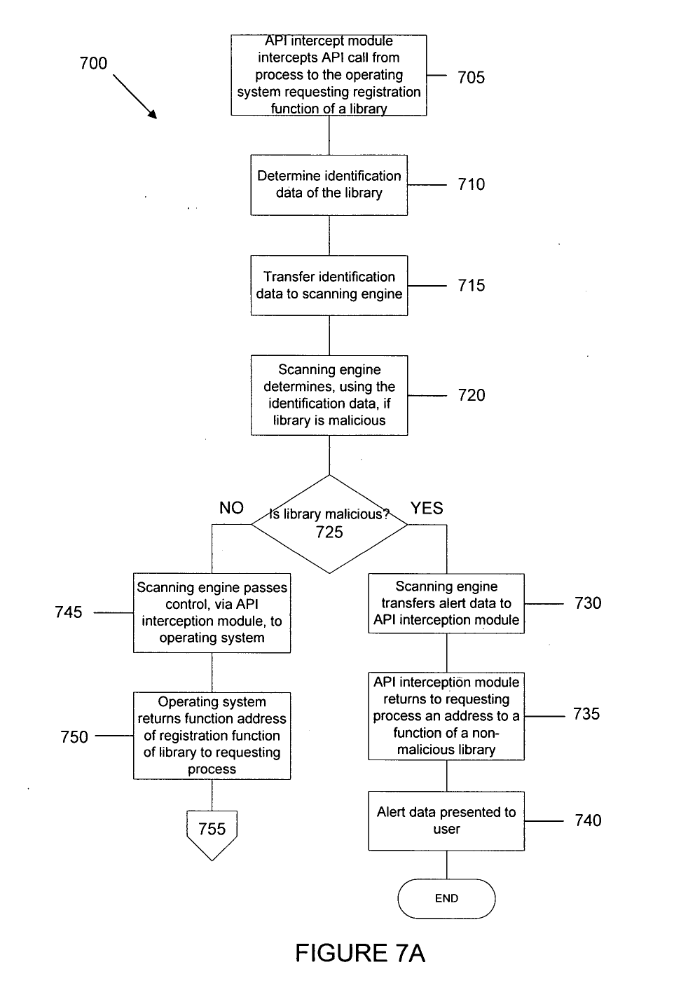

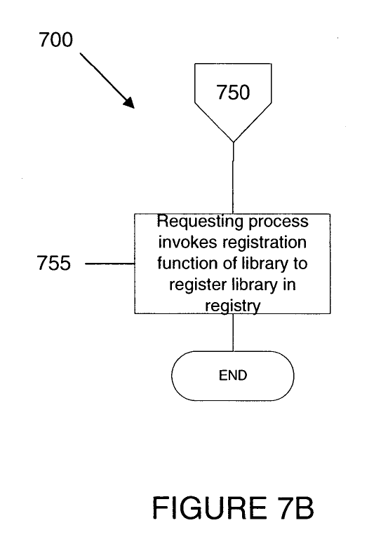

Referring now to FIGS. 7A and 7B, there is shown a flow diagram illustrating a more detailed example of the method illustrated in FIG. 6.

In particular at step 705 the method 700 comprises the API interception module 810 intercepting the API call from the process 210 to the operating system 220, where the API call is requesting the registration function of a library. At step 710 the method 700 comprises determining identification data of the library. At step 715, the method comprises transferring the identification data to the detection module 820. At step 720 the detection module 820 performs a scan, using the identification data to determine if the library is malicious. At step 725 if the detection module 820 determines that the library is malicious, the method 700 proceeds to step 730.

At step 730, the method 700 comprises the detection module 820 transferring alert data to the API interception module 810. The alert data is indicative of the identification of the library being malicious. At step 735 the method 700 comprises the API interception module 810 returning to the requesting process 210 an address to a function of a non-malicious library, thus restricting the registration of the malicious library. In one form, the non-malicious library may be a dummy library which performs no functionality. At step 740, the method 700 optionally comprises presenting to the user alert data indicating the identification of the malicious library.

Returning to step 725, in the event that the library is determined to be non-malicious, the method proceeds to step 745. At step 745, the method 700 comprises the detection engine 810 passing control via the API interception module 810, to the operating system 220. At step 750, the operating system 220 returns an address to the registration function of the library to the requesting process. At step 755, the method 700 comprises the requesting process 210 invoking the registration function of the library to register the library in the system registry 240.

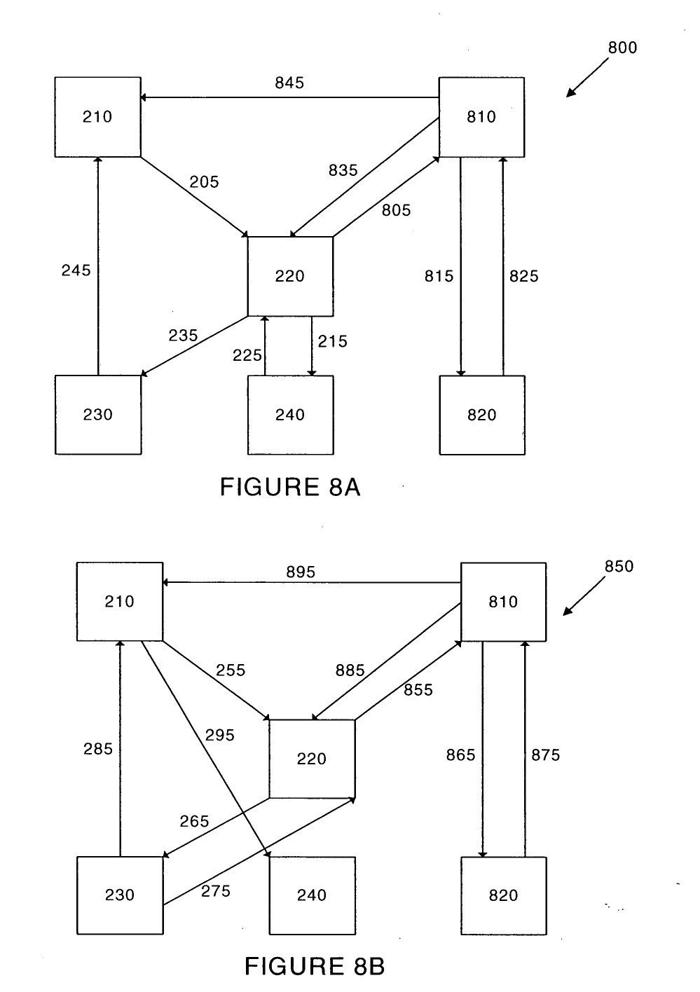

Referring now to FIG. 8A, there is shown a functional block diagram of an example system to restrict a request to load a malicious library in a processing system 100.

In particular, the process 210 transfers a request, indicated by arrow 205, to the operating system 220. The request to load the library is intercepted, indicated by arrow 805, by API interception module 810. The API interception module 810 transfers the request to the detection module 820 as indicated by arrow 815. The detection module 820 determines whether the library requested is malicious. The detection module 820 then proceeds to pass control, as indicated by arrow 825, to the API interception module 810. In the event that the detection module 820 determines that the library was malicious, the API interception module 810 passes error data, as indicated by arrow 845, to the requesting process 210, thus restricting the loading of the malicious library. In the event that the scanning engine 820 determined that the requested library was not malicious, the API interception module 810 passes control, as indicated by arrow 835, back to the operating system 220, where the normal process of loading the library as previously discussed in relation to FIG. 2A is performed such that the library is loaded in the processing system 100.

Referring now to FIG. 8B, there is shown a functional block diagram illustrating an example system to restrict a request to register a malicious library in a processing system 100.

In particular, the requesting process 210 passes a request, indicated by arrow 255, to the operating system 220 where the process requests the registration of a library. The API interception module 810 intercepts, as indicated by 855, the request to register the library. The API interception module 810 transfers the request, as indicated by arrow 865, to the detection module 820, wherein the detection module 820 performs an analysis of the library requested for registration. The detection module 820 transfers an indication of whether the library was determined to be malicious back to the API interception module 810, as indicated by arrow 875. In the event that the indication was indicative of the determination that the library was malicious, the API interception module 810 transfers an address, as indicated by arrow 895, to the requesting process 210 wherein the address points to a non-malicious registration function. In the event that the indication was indicative of the determination that the library was non-malicious, the API interception module transfers control, as indicated by arrow 885, to the operating system 220, such that the normal process for registering a library is performed, as outlined in FIG. 2B.

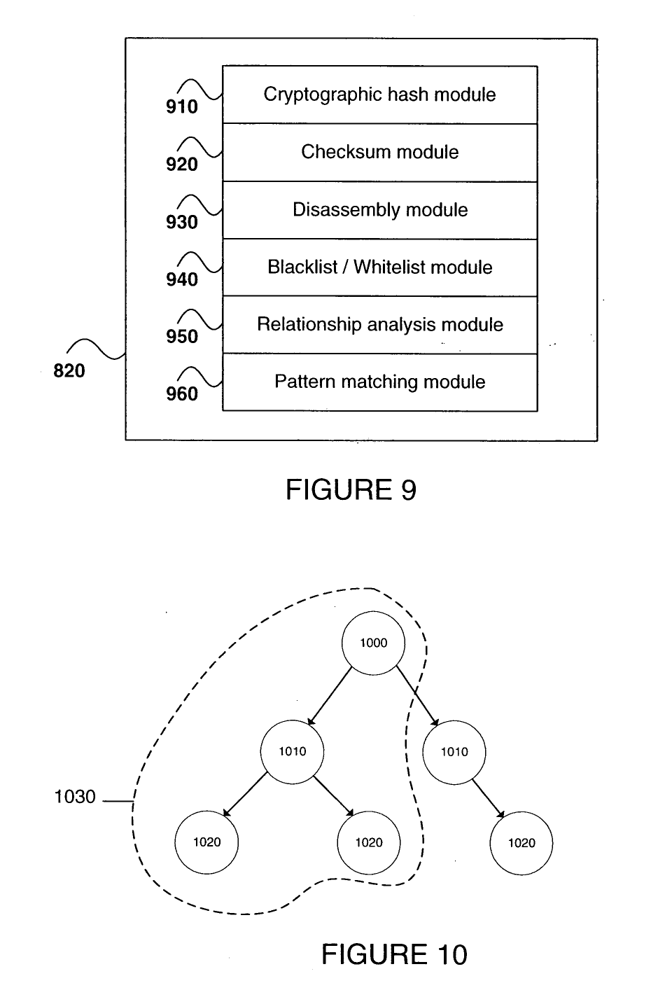

As shown in FIG. 9, the detection module 820 can comprise a number of further sub-modules to detect if the processing system 100 is being requested to load and/or register malicious libraries, or to determine references to a malicious library.

In particular, the detection module 820 can comprise the sub-modules of a cryptographic hash module 910, a checksum module 920, a disassembly module 930, a black-list/white-list module 940, a relationship analysis module 950, and a pattern matching module 960. The detection module 820 can be configured to use one or more of these sub-modules exclusively or in combination to determine if the processing system 100 is being requested to load and/or register a malicious library, or to determine references to a malicious library.

Referring now to the sub-modules of the detection module 820, the cryptographic hash module 910 of the detection module 820 is configured to generate a cryptographic hash value of an entity stored on a data storage component of the processing system 100. An entity can be a data object such as a file stored in the processing system 100. As the cryptographic hash value can be used an identity, the cryptographic hash value can be used in comparisons with the blacklist/whitelist module 940 to determine whether the entity is malicious.

The checksum module 920 of the detection module 820 is configured to determine a checksum of an entity of the processing system 100. The checksum can be compared to a database (blacklist/whitelist module 940) to determine whether the entity is malicious.

The disassembly module 930 is configured to disassemble the binary code stored for an entity such that the disassembly module 930 determines processing system instructions for the entity. The processing system instructions of the entity can then be used by the pattern matching module 960 to determine whether entity is malicious. Although strings of instructions can be compared by the pattern matching module 960, the pattern matching module 960 may be configured to perform functional comparisons of groups of instructions to determine whether the functionality of the entity is indicative of malware.

The blacklist/whitelist module 940 of the detection module 820 comprises a list of malicious and/or non-malicious entities. The blacklist/whitelist module 940 may be provided in the form of a table or database which comprises data indicative of malicious and non-malicious entities. The table may comprise checksums and cryptographic hash values for malicious and non-malicious entities. The data stored in the blacklist/whitelist module 940 can be used to determine whether an entity in the processing system 100 is malicious or non-malicious. The blacklist/whitelist module 940 can obtain the list of malicious/and or non-malicious entities and related data using the processing system's data storage component, such as the hard drive of the processing system 100, read-only media, read/write media, and/or a network connection.

The relationship analysis module 950 can be used to detect related malicious entities based on a detected base malicious entity 1000. As shown by example in FIG. 10, once a malicious entity 1000 has been detected, for example using one or more of the other sub-modules of the detection module 820, a web of related malicious entities 1030 can be determined using the relationship analysis module. Generally, malware comprises a bundle of malicious entities. Thus, by only removing a single malicious entity, the malware may not necessarily be disabled from performing some malicious activity. Therefore, detecting a group of malicious entities can be beneficial for disabling the malware.

The relationship analysis module 950 can be configured to determine one or more entity properties of the base malicious entity 1000. For example, the one or more entity properties could comprise a time which the base malicious entity was created or modified, and/or a directory which the entity is stored in a file system of the processing system 100. The relationship analyzer 950 can then perform a search of the data storage components for related entities 1010 which also share similar entity properties to the base malicious entity 1000.

The one or more related entities 1010 can then analyzed using one or more of the other sub-modules 910, 920, 930, 940, 960 of the detection module 820 to determine whether the one or more related entities are malicious. The related entities 1010 which are determined to be malicious 1030 can then be treated as base malicious entities, thereby iteratively determining a group of malicious related entities. In this instance, related entities 1020 can be determined based on malicious base entities 1010. The iterative process can terminate after an end condition is satisfied when no related entities are determined in a particular repetition; when no new related entities are determined in a particular repetition; when no related entities are determined in a period of time; when the base entity has an entity property which is indicative of the end condition; and when a selected number of repetitions have been performed. Other properties such as entity key words, functional relationships, and a network address which the entity was downloaded from which can also be used to determine related entities and potential malicious entities related to the base malicious entity. A more detailed explanation of applying a set of suspicious assessment rules in determining a suspicious/malicious entity is described in the Applicant's co-pending U.S. patent application Ser. No. 11/707,425 entitled “Determination of related entities”, the content of which is herein incorporated by cross-reference.

The pattern matching module 960 of the detection module 820 is configured to search an entity for particular patterns of strings or instructions which are indicative of malware such as malicious libraries. The pattern matching module 960 may operate in combination with the disassembly module 930 of the detection module 820.

Example pseudocode for implementing the method of restricting a request to load a malicious library is shown below.

```
Procedure initialization( )
Begin
  Call installApiInterception on sytemlibraryApi;
End;
Replacement systemApi;
Procedure systemApi:loadSystemLibraryById(id)
Begin
  Response = SendMessageToScanEngine(IS_ID_BAD, id);
  If Response = ID_IS_BAD Then
      Return ERROR_CODE;
      Exit procedure;
If (Response = ID_IS_OK) or (Response = IPC_ERROR) Then
      Return call REAL_loadSystemLibraryById(id);
      Exit procedure;
End;
Procedure systemApi:loadSystemLibraryByFileName(filename)
Begin
  Response = SendMessageToScanEngine(IS_FILE_BAD, filename);
  If Response = FILE_IS_BAD Then
      Return ERROR_CODE;
      Exit procedure;
If (Response = FILE_IS_OK) or (Response = IPC_ERROR) Then
      Return call REAL_loadSystemLibraryByFileName(filename);
      Exit procedure;
End;
```

Example pseudocode for implementing the method of restricting a request to register a malicious library is shown below.

```
Procedure initialization( )
Begin
  Call installApiInterception on sytemlibraryApi;
End;
Replacement systemApi;
Function systemApi:getFunctionAddress(libreference, functionname)
Begin
  If functionname = “DllRegisterServer” then begin
    Response = SendMessageToScanEngine(IS_LIB_BAD,
    libreference);
    If Response = LIB_IS_BAD Then
      Return AddressOfNonMaliciousFunction;
  End;
  Return call REAL_getfunctionAddress(libreference, functionname);
End;
Function NonMaliciousFunction( )
Begin
  SendMessageToUser(PREVENTED_REGISTRATION);
  Return FAILED;
End;
```

It will be appreciated that implementation of the above pseudocode in the form of a computer program can configure a processing system to restrict the request to load and/or register a malicious library.

The embodiments discussed in relation to restricting a process loading or registering a malicious library may be implemented separately or in any combination as a software package or component. Such software can then be used to pro-actively notify, restrict, and/or prevent malicious activity being performed using malicious libraries. Various embodiments can be implemented for use with the Microsoft Windows operating system or any other modern operating system.

In one optional form, such software may be invoked during the start-up process of the processing system 100. Alternatively, the user may invoke the software via the operating system of the processing system 100.

In another optional form, the user may be prompted regarding the identification of the request to load and/or register a malicious library. The user may then provide input, using the input device of the processing system 100, to indicate whether the user wishes for the loading or registration process to continue.

The above-described modules and submodules may be implemented in the form of hardware, software or a combination thereof.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

The claims defining the invention are as follows:

1. A method of restricting a request to load or register a malicious library in a processing system, the method comprising:
intercepting, in the processing system, a request to load or register a library;
determining if the library is malicious; and
in response to determining that the library is malicious, restricting the request to load or register the malicious library.

2. The method according to claim 1, wherein intercepting the request comprises intercepting, using an API hook function, an API call to request the library to load or register the library.

3. The method according to claim 2, wherein in the event that the library is determined to be malicious, the method comprises restricting the API call propagating through an API hook chain associated with the API call.

4. The method according to claim 1, wherein the method comprises:
determining identification data identifying the requested library; and
using a detection module and the identification data to determine if the library is malicious.

5. The method according to claim 1, wherein the method comprises analyzing, using the detection module, at least one of the intercepted request and a data storage element of the processing system to determine whether the library is malicious.

6. The method according to claim 5, wherein the detection module comprises one or more submodules comprising at least one of a cryptographic hash module, a checksum module, a disassembly module, a black-list/white-list module, a relationship analysis module, and a pattern matching module, wherein the method comprises analyzing, using the one or more submodules, at least one of the intercepted request and a data storage element of the processing system to determine whether the library is malicious.

7. The method according to claim 6, wherein the method comprises:
generating, using the cryptographic hash module, a cryptographic hash value of an entity associated with the request, wherein the entity is stored on or associated with the data storage element of the processing system; and
comparing the cryptographic hash value to a database to determine whether the library is malicious, wherein the database comprises a plurality of cryptographic hash values identifying malicious entities.

8. The method according to claim 6, wherein the method comprises:
generating, using the checksum module, a checksum value of an entity associated with the request, wherein the entity is stored on or associated with the data storage element of the processing system; and
comparing, using the black-list/white-list module, the checksum value to a list to determine whether the library is malicious, wherein the list comprises records indicative of malicious entities and non-malicious entities.

9. The method according to claim 6, wherein the method comprises:
disassembling, using the disassembly module, an entity associated with the request, wherein the entity is stored on or associated with the data storage element of the processing system; and
performing a comparison, using the pattern matching module, between the disassembled entity and a list of patterns associated with malicious activity.

10. The method according to claim 6, wherein in the event that the library is determined to be malicious, the method comprises:
(a) setting the malicious library as a base entity;
(b) determining an entity property of the base entity;
(c) determining, using the relationship analysis module, one or more related entities to the base entity which are related by the entity property; and
(d) performing, using the detection module, an analysis of the related entities to determine if one or more of the related entities are malicious.

11. The method according to claim 10, wherein the method comprises:
setting the one or more related entities as the base entity; and
repeating steps (b) and (c), followed by step (d) until an end condition is satisfied.

12. The method according to claim 11, wherein the end condition is at least one of:
when no related entities are determined in a particular repetition;
when no new related entities are determined in a particular repetition;
when no related entities are determined in a period of time;
when the base entity has an entity property which is indicative of the end condition; and
when a selected number of repetitions have been performed.

13. The method according to claim 1, wherein the method comprises:
in response to determining that the library is malicious:
scanning a system registry of the processing system for references to the malicious library; and
in the event of detecting a record in the system registry comprising a reference to the malicious library, removing the reference from the record.

14. A system to restrict a request to load or register a malicious library in a processing system, the system being configured to:
intercept, in the processing system, a request to load or register a library;
determine if the library is malicious; and
in response to determining that the library is malicious, restrict the request to load or register the malicious library.

15. The system according to claim 14, wherein the processing system is configured to intercept, using an API hook function, an API call to request the library to load or register the library.

16. The system according to claim 15, wherein in the event that the library is determined to be malicious, the system is configured to restrict the API call propagating through an API hook chain associated with the API call.

17. The system according to claim 14, wherein the processing system comprises a detection module, wherein the system is configured to:
determine identification data identifying the requested library; and
use the detection module and the identification data to determine if the library is malicious.

18. The system according to claim 17, wherein the detection module comprises one or more submodules comprising at least one of a cryptographic hash module, a checksum module, a disassembly module, a black-list/white-list module, a relationship analysis module, and a pattern matching module, wherein the system is configured to analyze, using the one or more of the submodules, at least one of the intercepted request and a data storage element of the processing system to determine whether the library is malicious.

19. The system according to claim 14, wherein in response to determining that the library is malicious, the system is configured to:
scan a system registry of the processing system for references to the malicious library; and
in the event of detecting a record in the system registry comprising a reference to the malicious library, remove the reference from the record.

20. A computer program product for a processing system, the computer program product comprising a computer readable medium having a computer program recorded therein or thereon, the computer program product being configured to enable restriction of a request to load or register a malicious library in the processing system, wherein the computer program product configures the processing system to:
intercept, in the processing system, a request to load or register a library;
determine if the library is malicious; and
in response to determining that the library is malicious, restrict the request to load or register the malicious library.
